(19) United States
(12) Patent Application Publication
(10) Pub. No.: US 2017/0284608 A1
(43) Pub. Date: Oct. 5, 2017

(54) FIXED STRUCTURE OF THE LIGHT BULB SHELL

(71) Applicant: Xiamen Eco Lighting Co., Ltd., Xiamen (CN)

(72) Inventors: Chengju Lin, Xiamen (CN); Fangwei Wei, Xiamen (CN); Liangliang Cao, Xiamen (CN)

(73) Assignee: Xiamen Eco Lighting Co., Ltd., Xiamen (CN)

(21) Appl. No.: 15/508,490

(22) PCT Filed: Jul. 28, 2016
(86) PCT No.: PCT/CN2016/091998

§ 371 Date: Mar. 3, 2017

(30) Foreign Application Priority Data
Oct. 20, 2015 (CN) 201510681510.4

(51) Int. Cl. F21K 9/237; F21V 7/04; F21V 19/00; F21K 9/232; F21V 3/02

(52) U.S. Cl. CPC F21K 9/237; F21K 9/232; F21V 3/02; F21V 19/003; F21V 7/04; F21Y 2115/10

(57) ABSTRACT

A light allocation item is set on a light source board to change the spread of the light comes out from the light source board. A light bulb shell shade is set around the light source board and the light allocation item. A bottom edge is set on the opening site of the bottom of the light bulb shell. The bottom edge is set around the light source board. A pressed device is set on light allocation item. The pressed device or the bottom edge is made of the elastic ingredients. The pressed device reaches to outside of the light source board to press the bottom edge of the light bulb shell. Setting the pressed device on the light allocation item makes the pressed device reach outside of the light source board. Therefore, the pressed device sets the bottom of the light bulb shell elastically to realize the fix.

### TECHNICAL FIELD

The present invention is related to an LED lighting device and more particularly related to a fixed structure of the light bulb shell.

### BACKGROUND

An LED light source owns the advantages of a high lighting efficiency, low radiation, low-battery usage and long lifetime. Therefore, the LED light is used more and more widely. The LED light replaces the traditional lighting devices like an incandescent lamp and a halogen lamp. In todays technology, the fix of a bulb shell commonly uses the way of gluing. However, having the pressure on the cost recently, the market gradually appears a variety of the buckle installation methods. In all the methods, buckling the bulb shell on the heat dissipation device and through the bulb pins to buckle on the heat dissipation device is the general way. This buckle method always exists the problem of insufficient strength and easily fallen. Requiring the coated adhesive realizes the fix of the bulb shell. Coated adhesive is not only disadvantage of environmental protection, but also for the professional gluing process. The installation process is complex.

### SUMMARY OF INVENTION

In view of this, it is necessary to provide the fixed structure of the light bulb shell with an automated installation.

A fixed structure of the light bulb shell includes a light source board, a light allocation item and a light bulb shell. The light allocation item is set on the light source board to change the spread of the light comes out from the light source board. The light bulb shell shade is set around the light source board and the light allocation item. The bottom edge is set on the opening site of the bottom of the light bulb shell. The bottom edge is set around the light source board. The pressed device is set on light allocation item. The pressed device or the bottom edge is made of the elastic ingredients. The pressed device reaches to outside of the light source board to press the bottom edge of the light bulb shell.

Comparing with the existed technology, the light bulb shell fixed structure sets the bottom edge through the bottom of the light bulb shell. Setting the pressed device on the light allocation item makes the pressed device reach outside of the light source board. Therefore, the pressed device sets the bottom of the light bulb shell elastically to realize the fix. Because save the gluing process makes the light bulb shell own the advantage of firm installation and easily to be automated installation.

### BRIEF DESCRIPTION OF DRAWINGS

FIG. 1 is the first embodiment main drawing for the present invention, the fixed structure of the light bulb shell.

FIG. 2 is the main sectional drawing from FIG. 1 that illustrates the fixed structure of the light bulb shell.

FIG. 3 is the stereoscopic decomposition drawing from FIG. 1 that illustrates the fixed structure of the light bulb shell.

### DETAILED DESCRIPTION

Though the attached drawing and the embodiment to describe the present invention detailed in following statement.

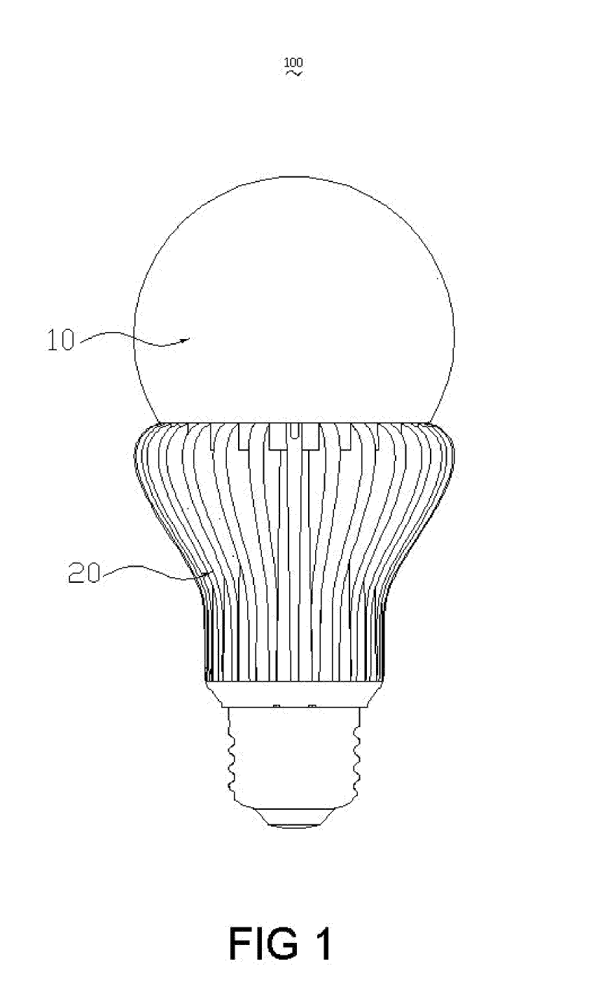

The first embodiment of the present invention, the fixed structure of the light bulb shell (10), please refer to FIG. 1 to FIG. 3.

Please refer to FIG. 1 to FIG. 3. A fixed structure of the light bulb shell (10) includes a light source board (40), a light allocation item (30) and a light bulb shell (10). The light allocation item (30) is set on the light source board (40) to change the spread of the light comes out from the light source board (40). The light bulb shell (10) shade is set around the light source board (40) and the light allocation item (30). The bottom edge (11) is set on the opening site of the bottom of the light bulb shell (10). The bottom edge (11) is set around the light source board (40). The pressed device (31) is set on light allocation item (30). The pressed device (31) or the bottom edge (11) is made of the elastic ingredients. The pressed device (31) reaches to outside of the light source board (40) to press the bottom edge (11) of the light bulb shell (10).

Setting the bottom edge (11) through the bottom of the light bulb and setting the pressed device (31) on the light allocation item (30) make the pressed device (31) reach out the light board (40). Therefore, the pressed device (31) presses the bottom edge (11) of the light bulb shell (10) elastically to realize the stable and make the light bulb shell (10) be firmly installed. The fixed structure of the light bulb shell owns the advantage of being not easy to loose and simple structure. Among them, the pressed device (31) and the bottom edge (11) are made of elastic ingredients to make the pressed device (31) and the bottom edge (11) be free match and installed to install the light bulb shell (10) conveniently.

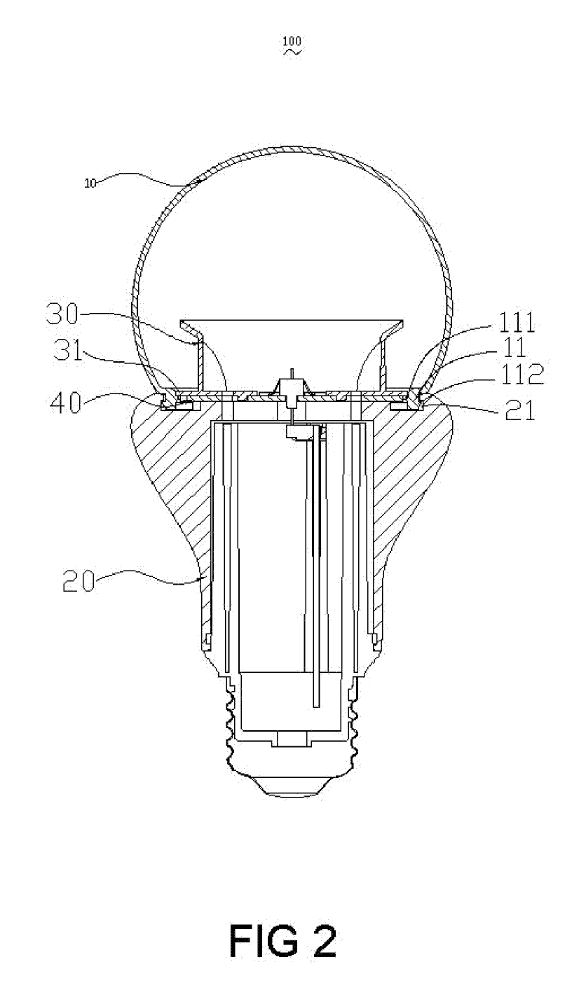

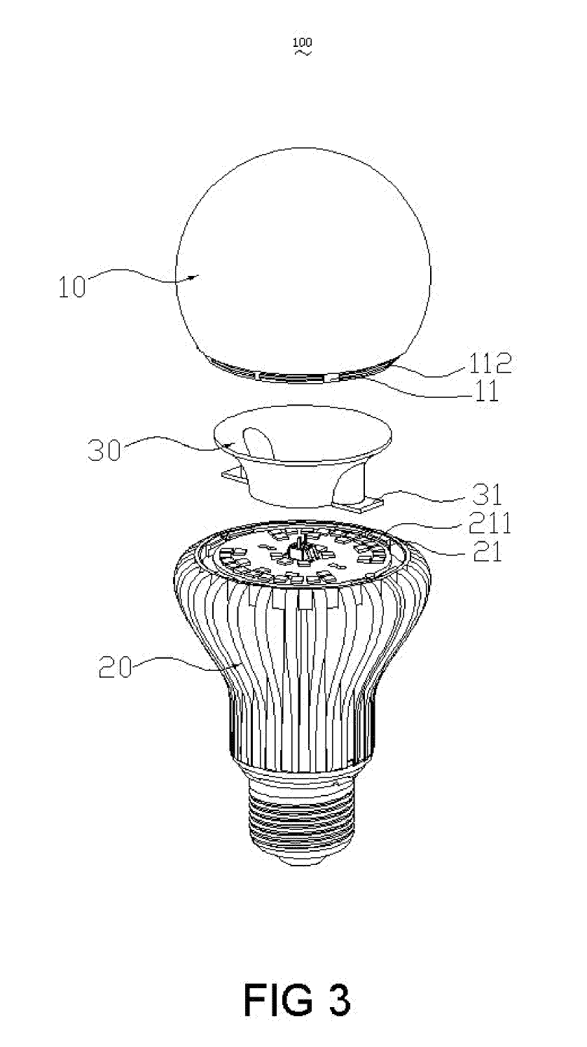

Please refer to FIG. 2 and FIG. 3. The bottom edge (11) of the light bulb shell (10) is the ring side structure and is set around the light board (40). The bottom edge (11) is set extended away from the light bulb shell (10). The inside of the bottom edge (11) of the light bulb shell (10) sets the bump (111). The pressed device (31) presses on the bump (111). Among them, setting the bottom edge (11) to be ring structure makes the whole shape structure of the light bulb shell (10) be more symmetry on one hand. On the other hand, setting the bottom edge (11) to be ring structure makes the bottom edge (11) be larger space, be convenient to set the installation of the firm structure and be sure to fix the light bulb shell (10) firmly. The inside of the bottom edge (11) matches the installation with the pressed device (31) through the bump (111) set on the side of inside. The fixed structure of the light bulb shell owns the advantages of the simple structure and the convenient installation.

Please refer to FIG. 2 and FIG. 3. The fixed structure of the light bulb shell includes the light body (20). The light source board (40) is fixed on the top of the light body (20). The light allocation item (30) is fixed above the light source board (40). The bottom edge (11) of the light bulb shell (10) is set between the pressed device (31) and the light body (20) of the light allocation item (30). The top of the light body (20) sets the situation slot (21). The bottom edge (11) of the light bulb shell (10) is stored in the situation slot (21) and relates to the situation slot (21). The outside of the bottom edge (11) of the light bulb shell (10) sets the positioning ring (112). The situation slot sets the buckle ring (211) relative to the positioning ring (112). The buckle ring (211) is buckled on the positioning ring (112).

Through setting the situation slot (21) on the light body (20), the buckle ring (211) on the situation slot, the relative positioning ring (112) on the outside of the light bulb shell (10) and buckling the positioning ring (112) on the buckle ring (211) realizes the firm installation. Therefore, the light bulb shell (10) is fixed on the light body (20) by the buckle to make the bottom edge (11) of the light bulb shell (10) set between the pressed device (31) and the light body (20) of the light allocation item (30). Promising the light bulb shell (10) to be firmly fixed on the light body (20) reduces the gluing process and owns the advantages of simple structure, convenient combination and not easy to loose.

Please refer to FIG. 2 and FIG. 3. The light allocation (30) is reflective ring. There are many LED light source set on the light source board (40) around the reflective ring. The reflective ring is used to reflect the light sent out from the LED light source toward the bottom of the light bulb shell (10). The light allocation item (30) is fixed on the light source board (40). The pressed device (31) is set on the bottom of the light allocation item (30).

In conclusion, through setting the bottom edge (11) on the bottom of the light bulb, setting the pressed item (31) on the light allocation item (30) reaches the pressed device (31) out of the light source board (40). Therefore, the pressed device (31) presses the bottom edge (11) of the light bulb shell (10) elastically to realize the firm and make the light bulb shell (10) be firmly installed. The inside of the bottom edge (11) of the light bulb shell (10) sets the bump (111). The pressed device (31) presses on the bump (111). The outside of the bottom edge (11) of the light bulb shell (10) sets the positioning ring (112). The situation slot sets the buckle ring (211) relative to the positioning ring (112). The buckle ring (211) is buckled on the positioning ring (112). Through setting the firm structure on the inside of the bottom edge (11) at the same time makes the bottom edge (11) of the light bulb shell (10) be set between the pressed device (31) and the light body (20) of the light allocation item (30). Promising the light bulb shell (10) may be firmly fixed on the light body (20) reduces the gluing process and owns the advantages of simple structure, convenient combination and not easy to loose.

It is understandable, the light source item (30) may be the structure of lens. Besides the light allocation item (30) is fixed on the light source board (40), the light allocation item may also be fixed on the light body (20). The light bulb shell (10) finally need the firm relative to the light body (20).

The statement above just for the better embodiment, not for limiting the present invention. All the modification, equal to any change and improvement that are based on the present invention's spirit and principle, may be protected in the present invention protection range.

1. A fixed structure of the light bulb shell comprising a light source board, a light allocation item and a light bulb shell, wherein the light allocation item is set on the light source board to change the spread of the light coming out from the light source board, the light bulb shell shade setting around the light source board and the light allocation item, the bottom edge setting on the opening site of the bottom of the light bulb shell, the bottom edge setting around the light source board; the pressed device setting on light allocation item, the pressed device or the bottom edge made of the elastic ingredients, the pressed device reaches to outside of the light source board to press the bottom edge of the light bulb shell.

2. The fixed structure of the light bulb shell of claim 1, characterized in that: the fixed structure of the light bulb shell includes the light body; the light source board is fixed on the top of the light body, the light allocation item is fixed above the light source board; the bottom edge of the light bulb shell is set between the pressed device and the light body of the light allocation item.

3. The fixed structure of the light bulb shell of claim 2, characterized in that: the top of the light body sets the situation slot; the bottom edge of the light bulb shell is stored in the situation slot and relates to the situation slot.

4. The fixed structure of the light bulb shell of claim 3, characterized in that: the bottom edge of the light bulb shell is the ring side structure and is set around the light board; the bottom edge is set extended away from the light bulb shell.

5. The fixed structure of the light bulb shell of claim 4, characterized in that: the inside of the bottom edge of the light bulb shell sets the bump; the pressed device presses on the bump.

6. The fixed structure of the light bulb shell of claim 4, characterized in that: the outside of the bottom edge of the light bulb shell sets the positioning ring;
the situation slot sets the buckle ring relative to the positioning ring; the buckle ring is buckled on the positioning ring.

7. The fixed structure of the light bulb shell of claim 1, characterized in that: the light allocation is reflective ring; there are many LED light source set on the light source board around the reflective ring; the reflective ring is used to reflect the light sent out from the LED light source toward the bottom of the light bulb shell.

8. The fixed structure of the light bulb shell of claim 7, characterized in that: the light allocation item is fixed on the light source board; the pressed device is set on the bottom of the light allocation item.
